(19) United States
(12) Patent Application Publication
(10) Pub. No.: US 2025/0209785 A1
(43) Pub. Date: Jun. 26, 2025

(54) METHOD AND DEVICE FOR DETERMINING FRAUD IN A BIOMETRIC-IMAGE RECOGNITION SYSTEM

(71) Applicant: IDEMIA IDENTITY & SECURITY FRANCE, Courbevoie (FR)

(72) Inventors: Jean BEAUDET, Courbevoie (FR); Loïc JEZEQUEL, Courbevoie (FR)

(73) Assignee: IDEMIA IDENTITY & SECURITY FRANCE, Courbevoie (FR)

(21) Appl. No.: 18/931,182

(22) Filed: Oct. 30, 2024

(30) Foreign Application Priority Data
Dec. 20, 2023 (FR) FR2314615

(51) Int. Cl. G06V 10/74; G06T 9/00; G06V 10/25; H04N 23/11

(52) U.S. Cl. CPC G06V 10/761; G06T 9/00; G06V 10/25; H04N 23/11

(57) ABSTRACT

A method for determining fraud in a biometric recognition system including obtaining a first image of a region of interest of a subject in a first wavelength band; obtaining a second image of the region of interest of the subject in a second wavelength band; encoding the first image by means of a first neural encoder, to obtain a first vector representation of the first image; encoding the second image by means of a second neural encoder, to obtain a second vector representation of the second image; computing a measure of similarity between the first vector representation and the second vector representation; and determining a fraud if the similarity measure is below a predefined threshold.

The invention relates to a method for determining fraud in a biometric-image recognition system based on analysis of at least two images of the same object, for example a face, obtained in at least two distinct wavelength bands.

Many biometric recognition systems for recognizing a person are based on analysis of images of the person. Generally, a particular part of the person, the region of interest, is used for recognition purposes. It may be a question of the face, but also of the fingerprint or iris of the person, this list being non-limiting.

Systems based on analysis of a single image, typically in the visible spectrum, of the region of interest allow a reasonable, although not perfect, recognition rate. In contrast such systems prove to be susceptible to fraud. They may be fooled by images constructed for this purpose and presented instead of the actual person's region of interest.

One way to make these systems more robust is to base recognition on a pair of images of the region of interest obtained in different wavelength bands, for example a first image obtained in the visible spectrum and a second image obtained in the infrared spectrum. This is one example, other wavelength bands being envisageable. The two images are then subjected, separately or concatenated, to a fraud detector. These systems allow the detection of fraud to be improved. For example, an image of a face presented instead of the actual face of the person, on a photograph or display, may produce a realistic image of the face in the visible but a black image in the infrared spectrum.

In these systems, the fraud detector is typically a classifier using neural networks trained to recognize attempts at fraud. A first classifier may specialize in the visible spectrum while a second classifier may specialize in the infrared spectrum. In this case, the result of the two classifiers is then consolidated to obtain the final result of the fraud detection. Alternatively, the two images are concatenated. For example, the infrared image is added as an additional component to the red, green, and blue components of the visible image. Alternatively, the infrared image replaces one of the components to obtain, for example, an RGIR image, i.e. an image in the red, green and infrared. It is then this image combining the two different wavelength bands that is delivered as input to a single classifier to detect fraud.

These systems detect fraud better, but are still inadequate. In particular, these classifiers are trained on facial poses, given expressions and for known fraud techniques. Confronted with a new pose, expression or fraud technology, their result is unpredictable.

The present invention aims to solve this problem.

### SUMMARY OF THE INVENTION

To this end, the invention proposes to subject the input images to encoding. Each image is encoded using an encoder based on a neural network. The result of the encoding is a vector of data representative of the image. Fraud is then detected by computing a similarity between the encoded representations of the images in each wavelength band. The encoders are trained conjointly to maximize the similarity of the encoded representations of images originating from the same person and to minimize similarity when this is not the case.

This way of doing things makes it possible to obtain better fraud-detection results compared to known classifier-based systems. In particular, confronted with a new fraud technology that was not taken into account during learning, the risk of fraudulent images producing similar representations is low. Furthermore, the invention improves robustness with respect to the conditions of image capture.

A method for determining fraud in a biometric recognition system is thus provided, characterized in that it comprises the following steps:
obtaining a first image of a region of interest of a subject in a first wavelength band;
obtaining a second image of the region of interest of the subject in a second wavelength band;
encoding the first image by means of a first neural encoder, to obtain a first vector representation of the first image;
encoding the second image by means of a second neural encoder, to obtain a second vector representation of the second image;
computing a measure of similarity between the first vector representation and the second vector representation; and
determining a fraud if the similarity measure is below a predefined threshold.

In certain embodiments, the first image and the second image are captured at the same time.

In certain embodiments, the first image and the second image are captured by the same camera using the same sensor.

In certain embodiments, the similarity measure is a normalized scalar product.

In certain embodiments, the first neural encoder and the second neural encoder are trained conjointly.

In certain embodiments, the first neural encoder and the second neural encoder are trained so as to maximize the similarity of the first and second vector representations for authentic images and to minimize the similarity of the first and second vector representations for fraudulent images or images not originating from the same acquisition.

In certain embodiments, the first wavelength band is in the visible spectrum, in particular between 380 and 780 nm, and the second wavelength band is in the infrared spectrum, in particular between 800 nm and 960 nm.

A computer program comprising instructions for implementing the method according to the invention, when this program is executed by a processor, is also provided.

A computer-readable non-transient recording medium on which there is recorded a program for implementing the method according to the invention, when this program is executed by a processor, is also provided.

A device for determining fraud in a biometric recognition system is also provided, characterized in that it comprises a processor configured to execute the following steps:
obtaining a first image of a region of interest of a subject in a first wavelength band;
obtaining a second image of the region of interest of the subject in a second wavelength band;
encoding the first image by means of a first neural encoder, to obtain a first vector representation of the first image;
encoding the second image by means of a second neural encoder, to obtain a second vector representation of the second image;
computing a measure of similarity between the first vector representation and the second vector representation;
determining a fraud if the similarity measure is below a predefined threshold.

The invention therefore makes it possible to achieve greater robustness with respect to the conditions of image capture, such as the orientation of the face relative to the camera. Specifically, unlike a classifier, a pose, i.e. the orientation of the face with respect to the camera, not seen during learning is an unknown datum, which could be processed wrongly, whereas with the invention, since the pose is identical in both images, it has little influence on the similarity between the two encoded images. Similarly, the invention makes it possible to achieve greater robustness with respect to changes in expression.

This program may use any programming language (for example an object language or the like) and take the form of an interpretable source code, of a partially compiled code or of a fully compiled code.

Another aspect relates to a non-transient storage medium for a computer-executable program, comprising a dataset representing one or more programs, said one or more programs comprising instructions for, during execution of said one or more programs by a computer comprising a processing unit operatively coupled to memory means and to an input/output interface module, executing all or some of the method described above.

### BRIEF DESCRIPTION OF THE DRAWINGS

Other features, details and advantages of the invention will become apparent upon reading the detailed description below. Said description is purely illustrative and should be read with reference to the appended drawings, in which:

FIG. 1 illustrates a fraud-detection system according to the prior art;

FIG. 2 illustrates a fraud-detection system according to one embodiment of the invention;

FIG. 3a and FIG. 3b illustrate training of a fraud-detection system according to a first example of embodiment of the invention;

FIG. 4 illustrates the main steps of a fraud detection method according to one example of embodiment of the invention;

FIG. 5 illustrates a schematic block diagram of an information-processing device for implementing one or more embodiments of the invention.

### DETAILED DESCRIPTION

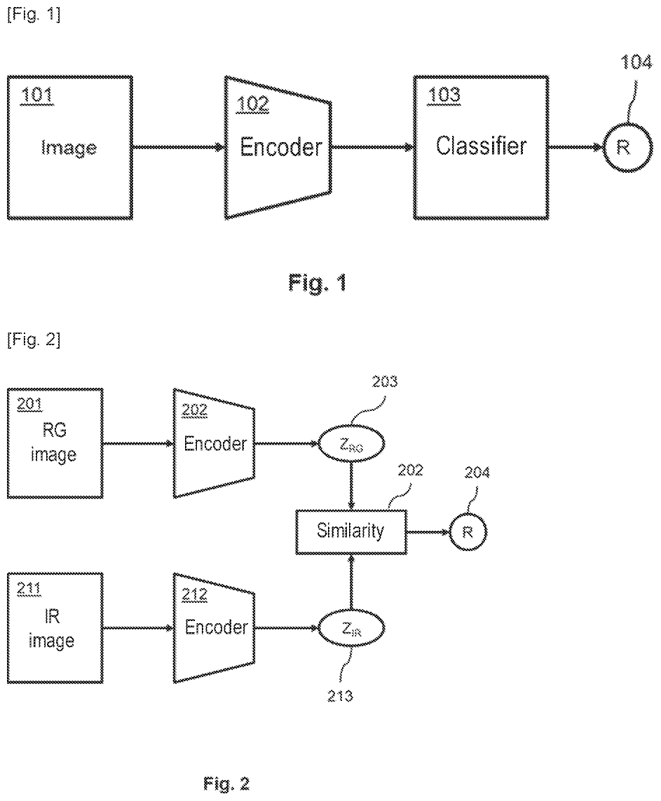

FIG. 1 illustrates a fraud-detection system according to the prior art.

The fraud-detection system is typically integrated into a larger application intended for recognition of a person. This recognition is based on one or more images of a region of interest of the person to be recognized. This region of interest is a face in the considered example of embodiment. However, the invention applies in the same way to other regions of interest, such as a fingertip for fingerprint recognition, or even an image of the person's eye for iris recognition.

Fraud attempts essentially aim to attempt to fool the recognition system. Typically, a person seeks to be identified by the system as another person. For example, a person presents a photograph of an authorized person in an attempt to gain access to a building or room under the control of the recognition system. This photograph may be presented in the form of a “paper” image or even be displayed on the display of a tablet for example.

Other fraud attempts simply consist in avoiding being identified. This may be the case with people wanted by the authorities for example. In this case, the fraud attempt aims to modify the appearance of the region of interest through makeup, accessories such as particular glasses, or objects put in the mouth to modify the contour of the cheeks of the individual.

The fraud-detection system receives as input an image 101 of the region of interest of the person that it is sought to identify. The image is typically taken by a camera. The subject may then be illuminated, to guarantee proper illumination of the region of interest.

The simplest systems use a single image 101 taken by a camera in the visible domain, i.e. in a wavelength band between 380 and 780 nm. Such an image 101 is typically a colour image having three components, one red, one green and one blue. This means that each point in the image is defined by three different numerical values, one red value, one green value and one blue value. These images are called RGB images.

More sophisticated systems couple the image in the domain of the visible wavelengths with a second image taken in another different wavelength band. For example, this second wavelength band may be the ultraviolet band, or even the infrared wavelength band between 800 nm and 860 nm, or indeed a band centred on 940 nm, and for example between 920 nm and 960 nm. In the non-limiting example of embodiment considered, the infrared band is used as second wavelength band. The choice of the second wavelength band is made depending on how the region of interest renders visually in this band; the choice is therefore open.

The choice of the infrared as second wavelength band has the advantage of being outside the visible spectrum. Specifically, most fraud attempts are designed to deceive the system in the visible, and the choice of a second wavelength band outside the visible spectrum generally makes it possible to thwart them. The infrared is also close to the visible, this facilitating focusing, particularly in the case of a single camera capturing the visible spectrum and infrared during the same acquisition.

A fourth component corresponding to the image in the infrared domain may then be added to the input image 101, a four-component RGBIR image then being spoken of. Alternatively, the infrared image replaces one of the components of the visible image, for example the blue component, an RGIR image then being spoken of. The input image is then a combined image, combining the two wavelength domains.

Alternatively, the visible and infrared images are not combined. The system illustrated in FIG. 1 is then duplicated. A first system processes the visible image and the second processes the infrared image, and the result of both systems is used to obtain the final result.

It is possible to use two different cameras to obtain the visible and infrared images. These cameras must be close to each other and synchronized to minimize a possible difference in pose between the two images.

Advantageously, a single camera is used, allowing both wavelength bands to be obtained using a single sensor. This solution is the one that gives the best results because it guarantees synchronization and the uniqueness of the pose of the subject between the two images.

The input image 101 is delivered to an encoder 102, to obtain a vector representation of the input image. This encoder is a neural network, for example one using the architecture called EfficientNet described in the article: “EfficientNet: Rethinking Model Scaling for Convolutional Neuronal Networks” by Mingxing Tan and Quoc V. Le.

The vector representation of the image is then submitted to a classifier 103 to produce a result 104. The classifier is also a neural network. The result is binary and gives the conclusion of the system as to the authenticity of the input image 101, namely whether the image is fraudulent or not. Alternatively, the result is a real number, for example between 0 and 1, that gives a probability that the input image 101 is a fraud.

Such a system is trained on a set of images that are known to be authentic (non-fraudulent) and of images that are known to be fraudulent. The fraudulent images used in the training are generated using known fraud techniques. This is one of the weaknesses of these systems. Confronted with a new fraud technique not envisaged during the training of the system, the result is not predictable. The system according to the invention thus improves the performance of such systems and makes them less sensitive to modifications of facial expression and pose.

FIG. 2 illustrates a fraud-detection system according to one embodiment of the invention.

This system receives as input two images 201 and 211 in two different wavelength bands of the subject and more precisely of the region of interest of the subject. Advantageously, these images are taken at the same time while minimizing the difference in viewing angle. As explained above, the best results are obtained with a single camera allowing both wavelength bands to be captured simultaneously by the same sensor. In this way it is guaranteed that the captures are perfectly synchronous and from exactly the same viewing angle.

In the considered example of embodiment, a single camera is used that produces an RGIR image, i.e. an image having three components-a red component, a green component and an infrared component.

Each image is then encoded by an encoder 202, 212, specialized for the wavelength band used. The encoder 202 is specialized in encoding RG images, while the encoder 212 is specialized in infrared images. The specialization of the encoders is obtained by training these neural networks on images in the given wavelength band.

The result 203, 213 of each encoder is a vector representation of their respective input image 201, 211.

Instead of submitting the vector representations of the images to a classifier as in the prior art, the decision 204 as to the fraudulent appearance of the input images is here deduced from a measure 202 of similarity between the two vector representations 203, 213 associated with the two input images in their respective wavelength bands.

The measure of similarity between the vector representations 203, 213 of the input images is determined, for example, via a normalized scalar product of the vectors forming these vector representations. This normalized scalar product corresponds to a cosine between the directions of the vectors. The result of the scalar product is then compared with a predefined threshold above which the similarity between the vectors is considered to be indicative of authentic images. Below the threshold, the input images are considered fraudulent. In the considered example of embodiment, the value of the threshold is set to 0.38.

Any other measure of similarity between the vectors may be used alternatively to the normalized scalar product; for example a measure of the Euclidean distance between the vectors may be used.

The method thus implemented has the advantage of being able to detect fraudulent images generated using new fraud techniques. Specifically, it is unlikely that the vector representations resulting from these new fraud techniques will be similar in the two analysed wavelength bands.

The method thus described may be generalized to more than two wavelength bands, a vector representation of each analysed band being generated. The similarity measure may then be determined pairwise between the obtained vector representations. As a variant, the average of the vector representations may be computed, then the scalar products between the vectors and this average computed. The result may then be produced by comparing each similarity measure with the predefined threshold, the images being determined to be authentic if none of the similarity measures exceeds the threshold. Alternatively, an average of the similarity measures may be compared with the predefined threshold to obtain the result.

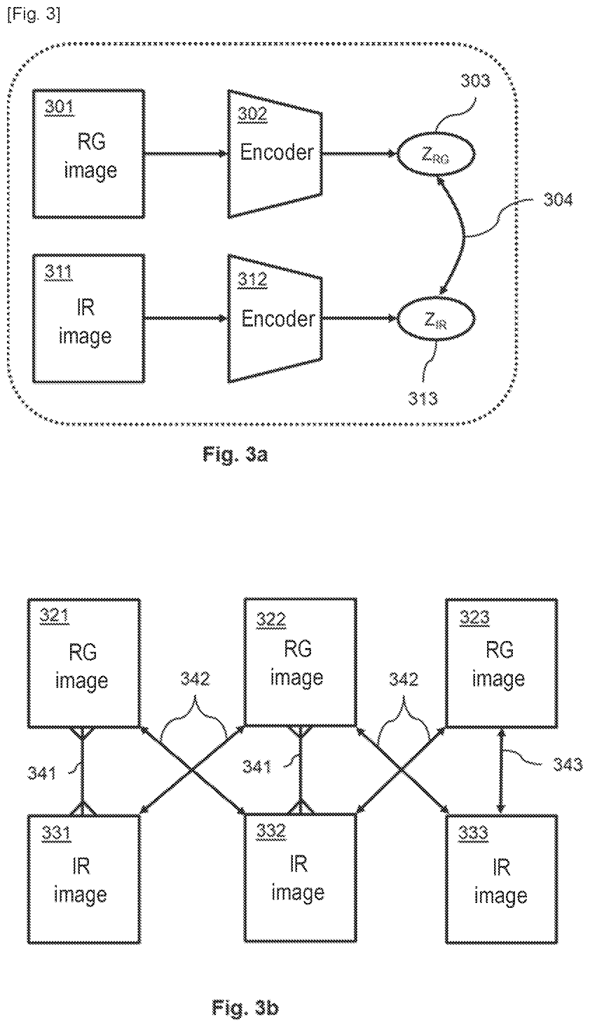

FIGS. 3a and 3b illustrate the training of the encoders 202 and 212 used by the fraud-detection system illustrated in FIG. 2.

The system of FIG. 3a uses input images 301 and 311 corresponding to the input images 201 and 211, and encoders 302 and 312 corresponding to the encoders 202 and 212, to generate vector representations 303 and 313. The two encoders 302 and 312 are trained conjointly so as to minimize or maximize the similarity 304 of the vector representations 303 and 313 depending on the input images 301 and 311.

FIG. 3b illustrates the processing of input images during training of the system. The image pairs (321, 331), (322, 332) and (323, 333) are input image pairs used during learning. The image pairs (321, 331) and (322, 332) are authentic image pairs, while the image pair (323, 333) is fraudulent. The learning consists in maximizing the similarity of the vector representations of the images 321 and 331 on the one hand, and the similarity of the vector representations of the images 322 and 332 on the other hand. This is illustrated by the links 341. Conversely, the similarity of the vector representations of images 321 and 332, 322 and 331, 322 and 333, 323 and 332, 323 and 333 is minimized. It is therefore a question of maximizing the similarity between the images of a given pair of authentic images and of minimizing the similarity between images belonging to pairs of different images, as represented by the arrows 342, and between two images of a given fraudulent pair, as represented by the arrow 343.

In the considered example of embodiment, this learning principle is applied through use, for example, of the following loss function:

$$ℒ = {\sum }_{i ∈ \{ live \}} - ( \frac{sim ( {Z}_{{IR}_{i}} , {Z}_{R {G}_{i}} )}{τ} ) + {\sum }_{i} log {\sum }_{j \neq i} exp ( \frac{s i m ( {Z}_{{IR}_{i}} , {Z}_{R {G}_{j}} )}{τ} ) + {λ}_{s p o o f} {\sum }_{i ∈ \{ s p o o f \}} ( \frac{s i m ( {Z}_{{IR}_{i}} , {Z}_{R {G}_{i}} )}{τ} ) \qquad [ Math . 1 ]$$

The indices i and j correspond to the pairs of images, which may belong to the set of pairs of authentic images, called the live set, or to the set of pairs of fraudulent images, called the spoof set. The function sim is the similarity function. The values Z are the vector representations indexed by the wavelength band and the index of the pair of images. τ is a “temperature” parameter, which for example has a value of 0.1 in the considered example of embodiment, and λ_{spoof} is a coefficient setting the relative importance of the various terms, and which for example has a value of 0.5 in the considered example of embodiment.

This contrastive learning is carried out in a conventional way by forming batches of pairs of images. In each batch, pairs of authentic images, pairs of fraudulent images and pairs of crossed images are formed, the images coming from various acquisitions. The above loss function encourages formation of similar vector representations for authentic pairs of images and of dissimilar vector representations for all the other pairs.

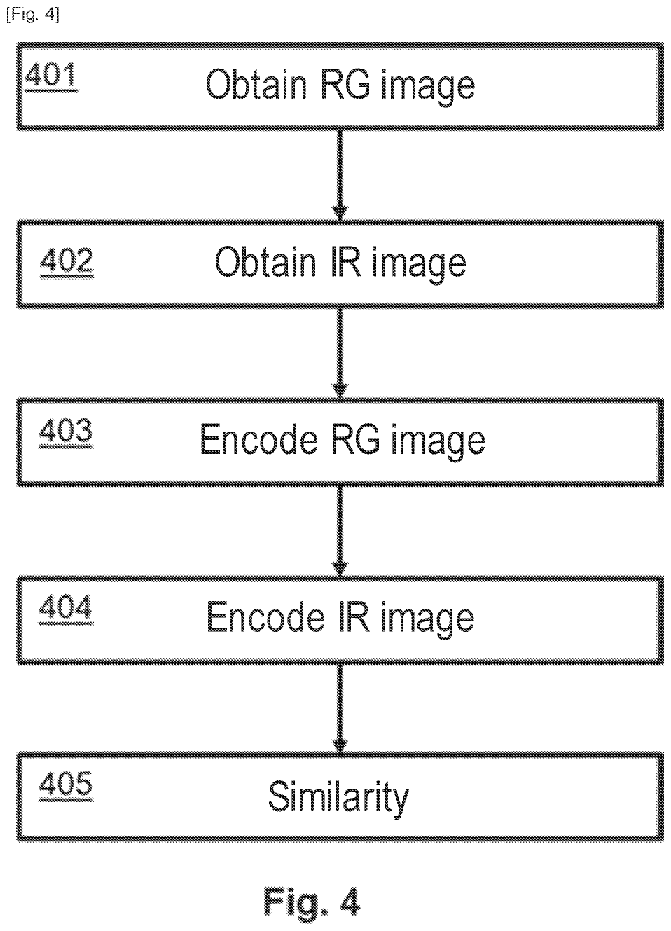

FIG. 4 illustrates the main steps of the fraud-detection method according to one embodiment of the invention.

In a step 401, a first image of the region of interest of a subject is obtained. This first image corresponds to a first wavelength band. In the considered example of embodiment, this first wavelength band is the visible spectrum.

In a step 402, a second image of the same region of interest of the subject is obtained. This second image corresponds to a second wavelength band. In the considered example of embodiment, this first wavelength band is the infrared spectrum.

In a step 403, the first image is encoded using a first neural encoder to produce a vector representation of the first image. This first neural encoder is trained on images corresponding to the first wavelength band.

In a step 404, the second image is encoded using a second neural encoder to produce a vector representation of the second image. This second neural encoder is trained on images corresponding to the second wavelength band.

In a step 405, the vector representations of the two images are compared using a similarity function, for example a normalized scalar product. The result of this similarity function is used to determine whether the input images are authentic or in contrast fraudulent. If the vector representations are sufficiently similar, as for example determined by comparing the result of the similarity function with a threshold, the input images are determined to be authentic.

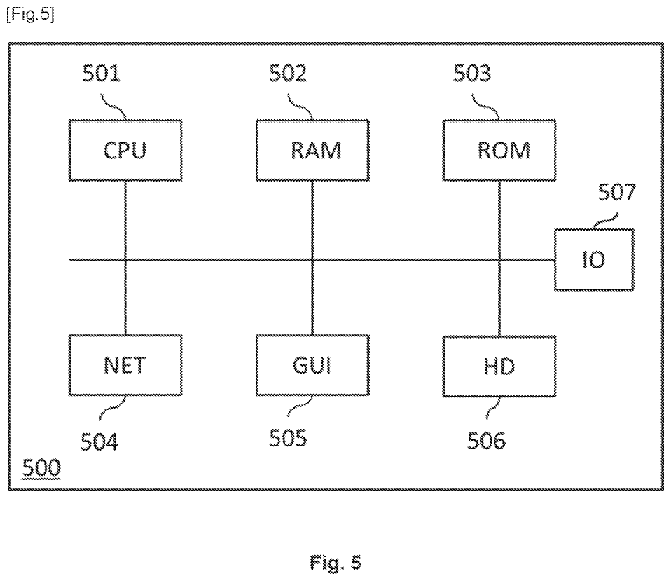

FIG. 5 illustrates a schematic block diagram of an information-processing device 500 for implementing one or more embodiments of the invention. The information-processing device 500 may be a peripheral such as a microcomputer, a workstation or a mobile telecommunication terminal. The device 500 comprises a communication bus connected to:
a central processing unit 501, such as a microprocessor, denoted CPU;
a random-access memory 502, denoted RAM, for storing the executable code of the method for carrying out the invention and containing registers suitable for storing the variables and parameters necessary for implementation of the method according to embodiments of the invention; the memory capacity of the device may be supplemented by an optional random-access memory connected to an expansion port, for example;
a read-only memory 503, denoted ROM, for storing computer programs for implementing the embodiments of the invention;
a network interface 504 is normally connected to a communication network over which digital data to be processed are transmitted or received. The network interface 504 may be a single network interface, or be composed of a set of different network interfaces (for example wired and wireless interfaces, or various types of wired or wireless interfaces). Data packets are sent over the network interface in transmission-mode or are read from the network interface in reception-mode under control of the software application running on the processor 501;
a user interface 505 for receiving inputs from a user or for displaying information to a user;
a storage device 506 such as described in the invention and denoted HD;
an input/output module 507 for receiving/sending data from/to external peripherals such as a hard disk, a removable storage medium, etc.

The executable code may be stored in a read-only memory 503, on the storage device 506 or on a removable digital medium such as, for example, a disk. According to one variant, the executable code of the programs may be received by means of a communication network, via the network interface 504, in order to be stored in one of the storage means of the communication device 500, such as the storage device 506, before being executed.

The central processing unit 501 is configured to control and direct execution of the instructions or of segments of software code of the program or programs according to one of the embodiments of the invention, which instructions are stored in one of the aforementioned storage means. After being turned on, the CPU 501 is capable of executing instructions from the main RAM 502 relating to a software application. Such software, when it is executed by the processor 501, causes the described methods to be executed.

In this embodiment, the apparatus 500 is a programmable apparatus which uses software to implement the invention. However, alternatively, the apparatus 500 may be implemented, in whole or in part, in hardware form (for example, in the form of an application-specific integrated circuit or ASIC).

Naturally, in order to meet specific needs, a person skilled in the art of the invention will be able to make modifications to the preceding description.

Although the present invention has been described above with reference to specific embodiments, the present invention is not limited to these specific embodiments, and modifications that fall within the field of application of the present invention will be obvious to a person skilled in the art.

Although they have been described through a certain number of detailed examples of embodiment, the proposed method and the equipment for implementing the method comprise various variants, modifications and refinements that will be obviously apparent to a person skilled in the art, it being understood that these various variants, modifications and refinements form part of the scope of the invention as defined by the following claims. In addition, various aspects and features described above may be implemented together, or separately, or else substituted for one another, and all of the various combinations and sub-combinations of the aspects and features form part of the scope of the invention. Furthermore, it may be the case that some systems and equipment described above do not incorporate all of the modules and functions described for the preferred embodiments.

1. A method for determining fraud in a biometric recognition system, the method comprising:
obtaining a first image of a region of interest of a subject in a first wavelength band;
obtaining a second image of the region of interest of the subject in a second wavelength band;
encoding the first image by means of a first neural encoder, to obtain a first vector representation of the first image;
encoding the second image by means of a second neural encoder, to obtain a second vector representation of the second image;
computing a measure of similarity between the first vector representation and the second vector representation; and
determining a fraud if the similarity measure is below a predefined threshold.

2. The method according to claim 1, wherein the first image and the second image are captured at the same time.

3. The method according to claim 2, wherein the first image and the second image are captured by the same camera using the same sensor.

4. The method according to claim 1, wherein the similarity measure is a normalized scalar product.

5. The method according to claim 1, wherein the first neural encoder and the second neural encoder are trained conjointly.

6. The method according to claim 5, wherein the first neural encoder and the second neural encoder are trained so as to maximize the similarity of the first and second vector representations for authentic images and to minimize the similarity of the first and second vector representations for fraudulent images or images not originating from the same acquisition.

7. The method according to claim 1, wherein the first wavelength band is in the visible spectrum between 380 and 780 nm and the second wavelength band is in the infrared spectrum between 800 nm and 960 nm.

8. (canceled)

9. A non-transitory computer-readable recording medium on which there is recorded a program for implementing the method according to claim 1 when the program is executed by a processor.

10. A device for determining fraud in a biometric recognition system, the device comprising:
a processor configured to:
obtain a first image of a region of interest of a subject in a first wavelength band;
obtain a second image of the region of interest of the subject in a second wavelength band;
encode the first image by means of a first neural encoder, to obtain a first vector representation of the first image;
encode the second image by means of a second neural encoder, to obtain a second vector representation of the second image;
compute a measure of similarity between the first vector representation and the second vector representation; and
determine a fraud if the similarity measure is below a predefined threshold.
